(19) United States
(12) Patent Application Publication
(10) Pub. No.: US 2014/0210574 A1
(43) Pub. Date: Jul. 31, 2014

(54) STRUCTURE OF BATTERY RELAY FOR VEHICLE

(71) Applicant: Hyundai Motor Company, Seoul (KR)

(72) Inventor: Geon-Jong LEE, Jeonju-si (KR)

(73) Assignee: HYUNDAI MOTOR COMPANY, Seoul (KR)

(21) Appl. No.: 14/071,391

(22) Filed: Nov. 4, 2013

(30) Foreign Application Priority Data
Jan. 30, 2013 (KR) 10-2013-0010524

(51) Int. Cl. H01H 50/00

(52) U.S. Cl. CPC H01H 50/00
USPC 335/2

(57) ABSTRACT

A structure of a battery relay is provided comprising a plunger movable upward and downward. The plunger comprises a lower portion, an upper portion, and an intermediate portion. A guide is fixed to a housing and supports the intermediate portion. A return spring is disposed on the lower portion and supports the plunger. A traveling contact is integrally formed with the plunger and movable upward and downward. A stationary contact is fixedly disposed at a lower side of the traveling contact. An exciting coil is connected to a battery switch and moves the plunger downward by being excited when the battery switch is turned on. A movable spring formed as a compression spring, is disposed on an upper portion of the traveling contact, and has one end fixed to an upper end of the plunger and another end fixed to an upper end of the guide.

### CROSS-REFERENCE TO RELATED APPLICATIONS

This application claims priority under 35 U.S.C. §119 to Korean Patent Application No. 10-2013-0010524, filed on Jan. 30, 2013, in the Korean Intellectual Property Office, the disclosure of which is incorporated herein by reference in its entirety.

### TECHNICAL FIELD

The present disclosure relates to a battery relay for a vehicle, and more particularly, to a structure of a battery relay for a vehicle in which a movable spring formed as a compression spring is disposed on an upper portion of a traveling contact in order to prevent a stationary contact and the traveling contact of the battery relay for a vehicle from being burned out, thereby preventing the stationary contact and the traveling contact from suddenly coming into contact with each other, and minimizing an occurrence of an arc at the time of turning off a contact point by allowing the plunger to rapidly return when the relay returns

### BACKGROUND

In general, a battery relay for a vehicle is a known means which turns on and off a battery power source which is supplied from a battery provided in a vehicle to a load side. The battery relay is generally applied to medium and large sized buses.

In general, the battery relay for a vehicle includes an integral type plunger, a return spring configured to elastically support the plunger, a traveling contact movable upward and downward, a stationary contact disposed at a lower side of the traveling contact, and an exciting coil connected to a battery switch. FIG. 1 illustrates a known battery relay for a vehicle.

The battery relay for a vehicle is driven by an operation of a battery switch. When the exciting coil is excited by turning on the battery switch, the traveling contact is operated to be lowered downward. By lowering the traveling contact, the traveling contact and the stationary contact come into contact with each other to form a contact point, and therefore the battery power source is supplied to a load side. The battery switch maintains an ON state when the vehicle travels, and therefore the power source is continuously supplied to a load side.

In contrast, when the battery switch is turned off, the contact point, which is formed by the traveling contact and the stationary contact, is released by the return spring, and the power source, which is supplied from the battery to a load side, is cut off.

However, in the battery relay for a vehicle of the related art, the traveling contact and the stationary contact may eccentrically come into contact with each other when the relay is operated, and a contact failure may occur due to the problem in which the traveling contact and the stationary contact eccentrically come into contact with each other.

In addition, as the traveling contact and the stationary contact suddenly come into contact with each other by exciting force applied to the traveling contact, an arc and a contact failure may occur, and there is a problem in that the contact point is burned out because of heat generated due to contact failure.

FIG. 2 illustrates an example in which the traveling contact and the stationary contact have been burned out as described above. As such, if the traveling contact and the stationary contact are burned out, because the power source is not supplied to the vehicle due to the problem in which the traveling contact and the stationary contact are burned out, there is a problem in that a defect in starting the vehicle may occur and other electronic components may not be used.

### SUMMARY

The present disclosure has been made in an effort to provide a battery relay for a vehicle in which a movable spring formed as a compression spring is disposed on an upper portion of a traveling contact in order to prevent a stationary contact and the traveling contact of the battery relay for a vehicle from being burned out, thereby preventing the stationary contact and the traveling contact from suddenly coming into contact with each other, and minimizing an occurrence of an arc at the time of turning off a contact point by allowing the plunger to rapidly return when the relay returns.

An exemplary embodiment of the present disclosure provides a structure of a battery relay for a vehicle, comprising a plunger movable upward and downward. The plunger comprises a lower portion, an upper portion, and an intermediate portion located between the lower and upper portions. A guide is fixed to a housing and is configured to support the intermediate portion of the plunger. A return spring is disposed on the lower portion of the plunger and is configured to provide a restoring force to the plunger to elastically support the plunger. A traveling contact is integrally formed with the plunger and is movable upward and downward. A stationary contact is disposed at a lower side of the traveling contact and is fixed so as not to be moved. An exciting coil is connected to a battery switch and is configured to move the plunger downward by being excited when the battery switch is turned on. A movable spring formed as a compression spring, is disposed on an upper portion of the traveling contact. The movable spring has one end fixed to an upper end of the plunger and an other end fixed to an upper end of the guide.

In a certain embodiment, the plunger includes a spring fixing groove at a center portion of the lower portion of the plunger, and the return spring is installed in the spring fixing groove.

In a certain embodiment, the structure further comprises a spring seat formed on the upper end of the plunger and configured to fix an end of the movable spring, and the one end of the movable spring is fixed to the spring seat.

The present disclosure having the aforementioned configurations allows initial movements of the plunger to be smooth by using the movable spring disposed at the upper portion of the traveling contact, and reduces an amount of arc that occurs when the contacts come into contact with each other, thereby improving contact performance between the traveling contact and the stationary contact.

In addition, an operational structure, which operates the movable spring, is formed as a dual operational structure of the movable spring and the return spring, and as a result, contact pressure between the traveling contact and the stationary contact is uniformly maintained, and contact damage due to contact failure between the contacts may be prevented.

In addition, as the movable spring and the return spring provide pressure by an elastic force on an upper portion and a lower portion of the plunger, left and right movements of the plunger may be prevented, and therefore the traveling contact and the stationary contact may be prevented from eccentrically coming into contact with each other.

Furthermore, because a problem of a defect in starting a vehicle, which is caused by a defect in relay operation due to damage to contacts by burning, may be improved by improving a relay contact structure, there is an effect in that the overall production quality of a vehicle and marketability may be improved.

### BRIEF DESCRIPTION OF THE DRAWINGS

FIG. 1 is a view illustrating a known battery relay for a vehicle.

FIG. 2 is a picture illustrating an example in which a traveling contact and a stationary contact of the known battery relay for a vehicle have been burned out.

FIG. 3 is a side cross-sectional view illustrating an exemplary embodiment of a structure of a battery relay for a vehicle of the present disclosure.

FIG. 4 is an enlarged view illustrating the structure of a battery relay for a vehicle of the present disclosure by partially enlarging main parts thereof.

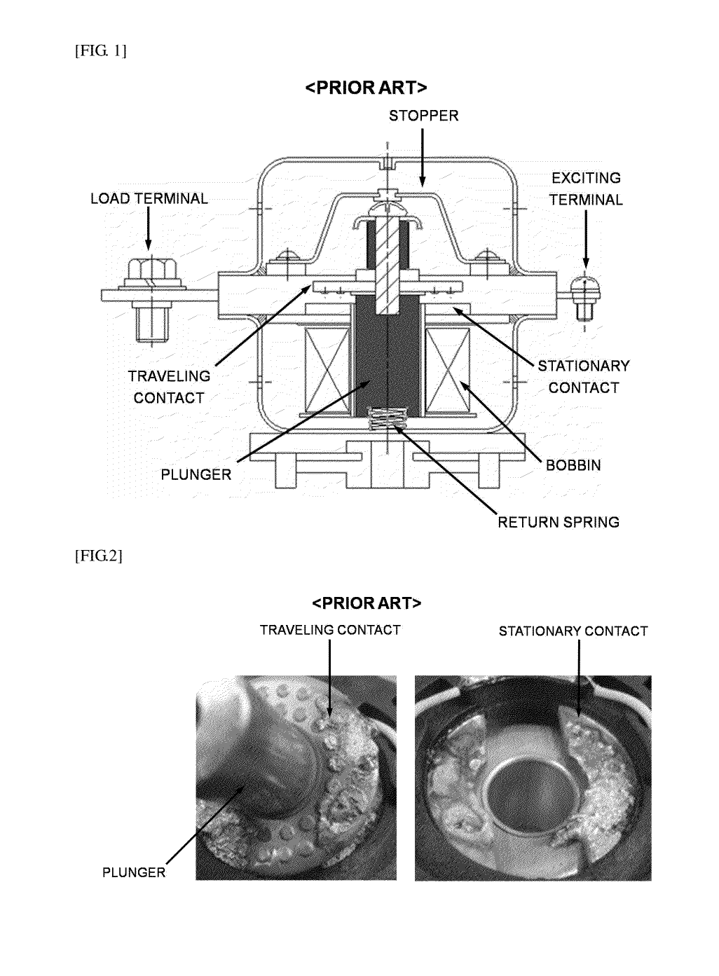

### DETAILED DESCRIPTION

Hereinafter, an exemplary embodiment of the present disclosure will be described in detail with reference to the drawings.

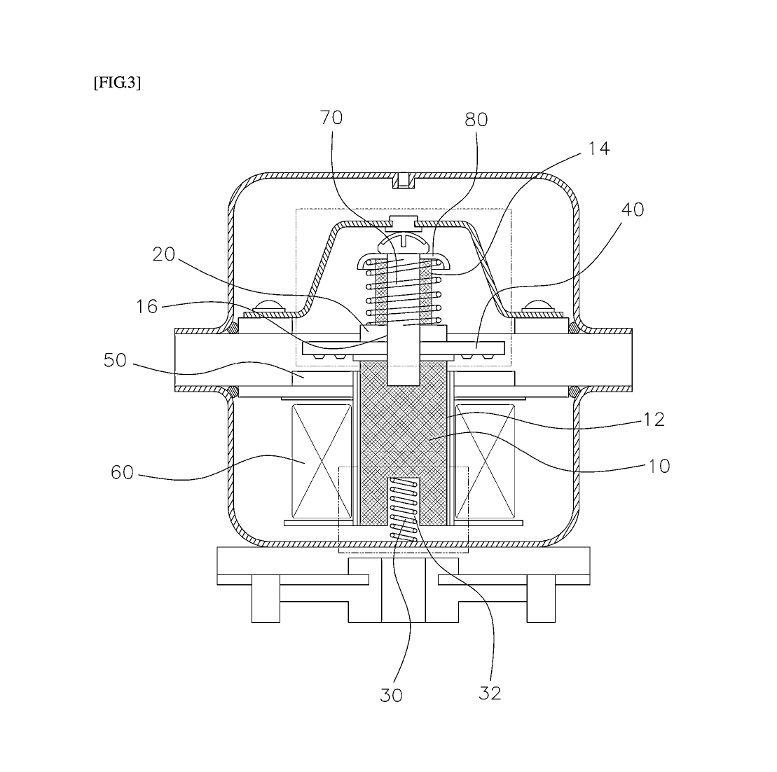

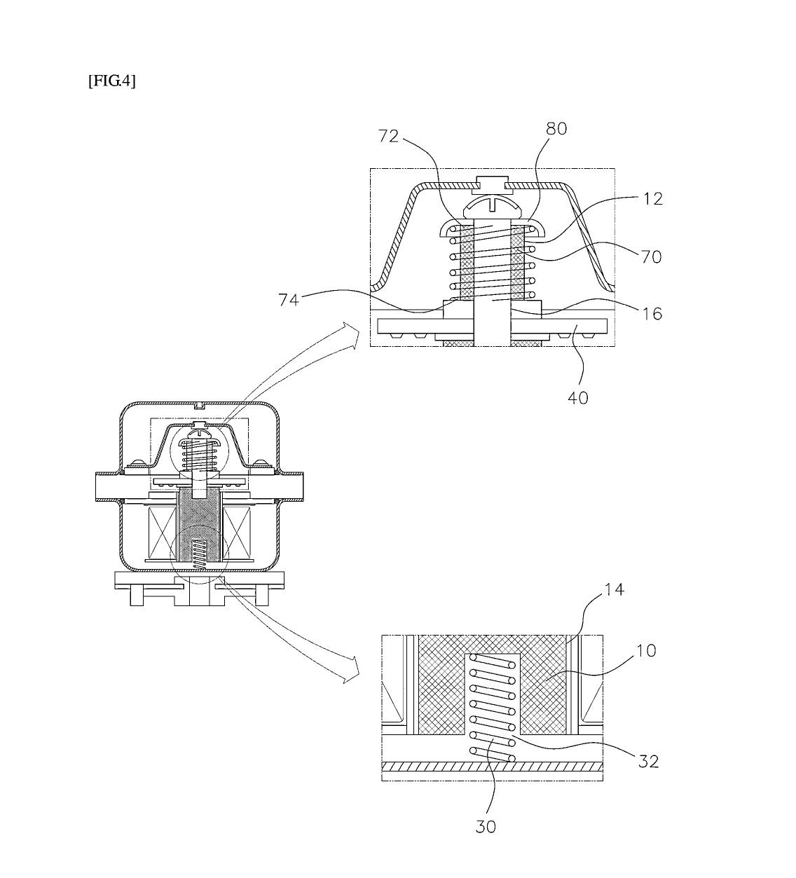

FIG. 3 is a side cross-sectional view illustrating an exemplary embodiment of a structure of a battery relay for a vehicle of the present disclosure, and FIG. 4 is an enlarged view illustrating the structure of a battery relay for a vehicle of the present disclosure by partially enlarging the main parts thereof.

As illustrated, the structure of a battery relay for a vehicle of the present disclosure is similar to a structure of a battery relay for a vehicle of the related art, and further includes a movable spring 70 configured to provide an elastic force to a traveling contact 40.

In other words, the battery relay for a vehicle of the present disclosure generally includes a plunger 10 movable upward and downward. The plunger comprises a lower portion 12, an upper portion 14, and an intermediate portion 16 located between the first and second portions 12, 14. A guide 20 is formed to be fixed to a housing and configured to support the plunger 10 so as to prevent the plunger 10 from being moved in a lateral direction. In a certain embodiment, the guide supports the intermediate portion of the plunger 16. A return spring 30 is configured to provide a restoring force to the plunger 10 to elastically support the plunger 10. The traveling contact 40 is integrally formed with the plunger 10 and is movable upward and downward. A stationary contact 50 is disposed at a lower side of the traveling contact 40. An exciting coil 60 is connected to a battery switch. The movable spring 70 is disposed at an upper portion of the traveling contact 40 and is configured to apply an elastic force to a spring seat 80 formed on an uppermost end of the plunger 10.

The movable spring 70 is formed as a compression spring. As an upper end of the movable spring 72 is fixed to the spring seat 80 and a lower end of the movable spring 74 is fixed to an upper portion of the guide 20, the movable spring 70 provides an effect of preventing the stationary contact 50 from being rapidly moved downward by applying elastic force opposite to downward movements of the stationary contact 50 and the plunger 10.

Therefore, the structure of the battery relay for a vehicle of the present disclosure initially allows upward and downward movements of the plunger 10 to be smooth by elastic force by using the movable spring 70 disposed at the upper side of the traveling contact 40, and reduces an amount of arc that occurs when the contacts come into contact with each other, thereby improving contact performance between the traveling contact 40 and the stationary contact 50.

Here, the upward and downward movements of the plunger 10 are affected by a dual operational structure of the movable spring 70 and the return spring 30. Therefore, as contact pressure between the traveling contact 40 and the stationary contact 50 is doubly and uniformly maintained by the movable spring 70 and the return spring 30, a structure is provided in which a contact state between the traveling contact 40 and the stationary contact 50 may be normally maintained. Therefore, the structure of the battery relay for a vehicle of the present disclosure is formed as a structure in which contact damage, which may occur due to contact failure between the traveling contact 40 and the stationary contact 50, may be prevented.

In addition, the aforementioned dual structure according to the movable spring 70 and the return spring 30 simultaneously provides pressure by an elastic force on an upper portion 12 and a lower portion 14 of the plunger 10 and thus provides an effect of fixing the upper portion 12 and the lower portion 14 of the plunger 10. Therefore, left and right movements of the plunger 10 may be prevented, and therefore, the traveling contact 40 and the stationary contact 50 may be prevented from eccentrically coming into contact with each other.

Meanwhile, in the exemplary embodiment of the present disclosure, a spring fixing groove 32, in which the return spring 30 may be accommodated, is formed in a lower portion of the plunger 10 in order to prevent a deviation from being generated due to a lateral movement of the plunger 10. Therefore, an upper end of the return spring 30 comes into contact with the plunger 10, and a contact point between the return spring 30 and the plunger 10 is positioned closer to a center portion of the plunger 10, thereby preventing the plunger 10 from being moved in a lateral direction. Therefore, the left and right movements of the plunger 10 may be prevented by the spring fixing groove 32, and therefore the traveling contact 40 may come into parallel contact with the stationary contact 50 because deviation is prevented.

Hereinafter, an operation of the structure of the battery relay for a vehicle of the present disclosure, which is configured as described above, will be described step by step in detail.

The structure of the battery relay for a vehicle of the present disclosure is driven by an operation of the battery switch. When a voltage is applied to the exciting coil 60 by turning on the battery switch, the plunger 10 is moved downward by receiving a force greater than an elastic force applied by the return spring 30, and the traveling contact 40, which is integrally formed with the plunger 10, is moved downward by the downward movement of the plunger 10 to come into contact with the stationary contact 50 and form the contact point.

At this time, the downward movement of the plunger 10 is performed through two steps. At an initial stage, when the relay is excited by turning on the battery switch, the movable spring 70, formed as the compression spring, first provides an elastic force to the plunger 10 to prevent the plunger 10 from suddenly coming into contact with the stationary contact 50.

Thereafter, when a magnetic field of the coil is saturated, the spring seat 80 is moved downward by the downward movement of the plunger 10 while overcoming the force of the movable spring 70, and the traveling contact 40 maintains a contact state with the stationary contact 50 by pressure applied downward.

Meanwhile, when the relay returns as the battery switch is turned off, the force compressing the return spring 30 and the movable spring 70 is removed, such that compression of the return spring 30 and the movable spring 70 is released. Accordingly, as the plunger 10 rapidly returns in an upper direction, an amount of arc, which may occur when the stationary contact 50 and the traveling contact 40 come out of contact with each other, is minimized Therefore, contact damage, which is generated by the arc, may be prevented.

While the exemplary embodiment of the present disclosure with respect to the structure of the battery relay for a vehicle has been described in detail above, the exemplary embodiment is only a specific example for easy understanding of the present disclosure, and the present disclosure is not limited thereto. Here, it is obvious to a person skilled in the art that besides the exemplary embodiments disclosed herein, various modifications can be made based on the technical spirit of the present disclosure.

What is claimed is:

1. A structure of a battery relay for a vehicle, comprising:
a plunger movable upward and downward, wherein the plunger comprises a lower portion, an upper portion, and an intermediate portion located between the lower and upper portions;
a guide fixed to a housing and configured to support the intermediate portion of the plunger;
a return spring disposed on the lower portion of the plunger and configured to provide a restoring force to the plunger to elastically support the plunger;
a traveling contact integrally formed with the plunger and movable upward and downward;
a stationary contact disposed at a lower side of the traveling contact and fixed so as not to be moved;
an exciting coil connected to a battery switch and configured to move the plunger downward by being excited when the battery switch is turned on; and
a movable spring formed as a compression spring, disposed on an upper portion of the traveling contact, and having one end fixed to an upper end of the plunger and an other end fixed to an upper end of the guide.

2. The structure of claim 1, wherein the plunger includes a spring fixing groove at a center portion of the lower portion of the plunger, and the return spring is installed in the spring fixing groove.

3. The structure of claim 1, further comprising:
a spring seat formed on the upper end of the plunger and configured to fix an end of the movable spring, and
the one end of the movable spring is fixed to the spring seat.
